(19) United States
(12) Patent Application Publication
(10) Pub. No.: US 2024/0175214 A1
(43) Pub. Date: May 30, 2024

(54) FILTER MATERIAL FOR FOOD PACKAGING

(71) Applicant: Glatfelter GERNSBACH GMBH, Gernsbach (DE)

(72) Inventors: Andrew K. Jordan, Monmouth (GB); Denis Ingildeev, Gernsbach (DE); Béatrice Passerat, Baden-Baden (DE)

(21) Appl. No.: 18/284,958

(22) PCT Filed: Mar. 28, 2022
(86) PCT No.: PCT/EP2022/058129

§ 371 Date: Sep. 29, 2023

(30) Foreign Application Priority Data
Mar. 31, 2021 (EP) 21290019.5

(51) Int. Cl. D21H 27/08; B01D 39/16; B01D 39/18; B65D 85/808; D21H 19/28; D21H 21/20; D21H 23/52; D21H 23/70; D21H 27/10

(52) U.S. Cl. CPC D21H 27/08; B01D 39/163; B01D 39/18; B65D 85/808; D21H 19/28; D21H 21/20; D21H 23/52; D21H 23/70; D21H 27/10; B01D 2239/0266; B01D 2239/0428; B01D 2239/086; B01D 2239/10; B01D 2239/1291

(57) ABSTRACT

The present invention relates to a filter material having advantageous properties in terms of sustainability and/or strength, the use of a non-fibrous binder for enhancing certain properties of a filter material, a process for producing the filter material and food packaging, in particular tea bags, made from the filter material. The filter material comprises fibers and at least one non-fibrous binder selected from the group consisting of poly lactic acid, polyglycolic acid and copolymers.

### FIELD OF THE INVENTION

The present invention relates to a filter material having advantageous properties in terms of sustainability (such as natural basis and/or biodegradability) and/or strength (in particular wet tensile strength and/or wet crimp strength), the use of a non-fibrous binder for enhancing certain properties, more specifically wet tensile strength and/or wet crimp strength, of a filter material, a process for producing the filter material and food packaging, in particular tea bags, made from the filter material.

### BACKGROUND

Food packaging for the preparation of hot and cold beverages, such as tea bags, typically contain a synthetic plastic binder to improve the manual folded crimp down the center of the hot and cold beverage bags that keeps the contents in, and to improve other physical properties such as tea dust retention and stretch properties of the paper web. However, such synthetic plastic material generally requires many hundreds of years to break down in the environment. Over the last years, concerns about plastic contamination of the environment have created an increasing demand for fully compostable/biodegradable filter materials that can be suitably used for food packaging including tea bags.

Not only the biodegradability or compostability of such filter material becomes a more and more important topic, but also the finiteness of fossil resources creates a demand for biobased, such as plant-based, materials that may replace the conventional, oil-based plastic materials, such as the synthetic plastic binder typically used in food packaging for the preparation of hot and cold beverages, as described in the foregoing.

Thus, there may be a need for a filter material for hot and cold beverage bags or food packaging that make use of a biodegradable, industrial and home compostable plant-based binder material that meets the requirements of a current hot and cold beverage bag using existing synthetic binder materials.

### OBJECT OF THE INVENTION

The present invention aims at overcoming the above described problems and drawbacks. Thus, it is an object of the present invention to provide a filter material wherein a biobased and/or biodegradable binder material is used which enhances certain properties, in particular wet tensile strength and/or wet crimp strength, of a filter material suitable for the preparation of hot and cold beverages, in particular for a tea bag.

### SUMMARY OF THE INVENTION

The present inventors have made diligent studies for solving this object and have found that this object can be solved by the use of a non-fibrous (or particulate) (in particular hydrophobic) binder selected from the group consisting of polylactic acid, polyglycolic acid and copolymers thereof. Typically, tea bags use a folded center crimp to ensure no leakage of contents. The inventors have in particular found that these specific biobased and biodegradable binders may firmly bind to (in particular natural cellulosic) fibers, may be hydrophobic and may prevent water ingress into the crimped area, thus enhancing the strength of the crimp. As an additional benefit, the binder may create a more permanent fold that is more difficult to open. As a further enhancement, without wishing to be bound to any theory, the binder may help to modify the filter material by reducing its pore size and numbers thereby reducing the transfer of the contents dust through the filter material and into the outer packaging.

Accordingly, the present invention relates to a filter material (in particular for the preparation of hot and cold beverages, in particular for a tea bag), comprising (a) fibers, and (b) at least one non-fibrous (or particulate) (in particular hydrophobic) binder selected from the group consisting of polylactic acid, polyglycolic acid and copolymers thereof (e.g. poly(lactic-co-glycolic acid)).

The present invention further relates to the use of a non-fibrous (particulate) binder selected from the group consisting of polylactic acid, polyglycolic acid and copolymers thereof for enhancing wet tensile strength and/or wet crimp strength of a filter material.

Moreover, the present invention relates to a process for producing a filter material, comprising the steps of providing a web comprising fibers, and applying at least one non-fibrous (particulate) binder selected from the group consisting of polylactic acid, polyglycolic acid and copolymers thereof to the web.

In addition, the present invention further relates to a food packaging, in particular a tea bag, comprising or made from the filter material as described herein.

Other objects and many of the attendant advantages of embodiments of the present invention will be readily appreciated and become better understood by reference to the following detailed description of embodiments and the accompanying drawings.

### BRIEF DESCRIPTION OF THE DRAWINGS

FIG. 1 illustrates exemplary stages in non-heatseal double chamber bag formation.

FIG. 2 illustrates the non-heatseal paper crimp formation.

FIG. 3 is a graphical illustration of experimental results of measurements of the dry tensile strength of filter materials.

FIG. 4 is a graphical illustration of experimental results of measurements of the wet tensile strength of filter materials.

FIG. 5 is a graphical illustration of experimental results of measurements of the dry crimp strength of filter materials.

FIG. 6 is a graphical illustration of experimental results of measurements of the wet crimp strength of filter materials.

FIG. 7 is a graphical illustration of experimental results of measurements of the water climb (wicking) of filter materials.

### DETAILED DESCRIPTION OF THE INVENTION

Hereinafter, details of the present invention and other features and advantages thereof will be described. However, the present invention is not limited to the following specific descriptions, but they are rather for illustrative purposes only.

It should be noted that features described in connection with one exemplary embodiment or exemplary aspect may be combined with any other exemplary embodiment or exemplary aspect, in particular features described with any exemplary embodiment of a filter material may be combined with any other exemplary embodiment of a filter material, with any exemplary embodiment of the use of a non-fibrous binder, with any exemplary embodiment of a process for producing a filter material or with any exemplary embodiment of a food packaging and vice versa, unless specifically stated otherwise.

Where an indefinite or definite article is used when referring to a singular term, such as “a”, “an” or “the”, a plural of that term is also included and vice versa, unless specifically stated otherwise, whereas the word “one” or the number “1”, as used herein, typically means “just one” or “exactly one”.

The expression “comprising”, as used herein, includes not only the meaning of “comprising”, “including” or “containing”, but may also encompass “consisting essentially of” and “consisting of”.

In a first aspect, the present invention relates to a filter material.

The term “filter material”, as used herein, may in particular mean a fibrous product that possess filtration or infusion characteristics to a certain degree. The filter material may include a nonwoven web (which may also be referred to as “fabric” or “paper”), such as a web of individual fibers which are intertwined, but not in a regular manner as in a knitted or woven fabric.

In an embodiment, the filter material is suitable for the preparation of hot and cold beverages. In other words, the filter material may exhibit filtration or infusion characteristics that allow the preparation of hot and cold (infusion) beverages, such as tea or coffee. In particular, the filter material should meet all food legislation standards for cold and hot beverages.

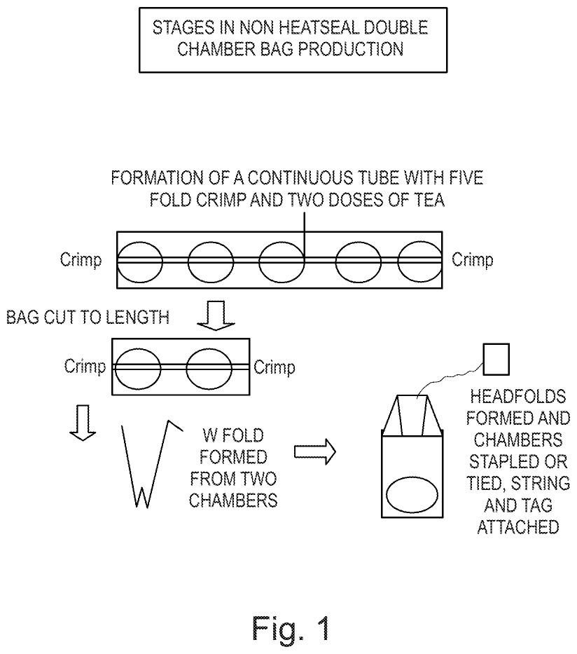

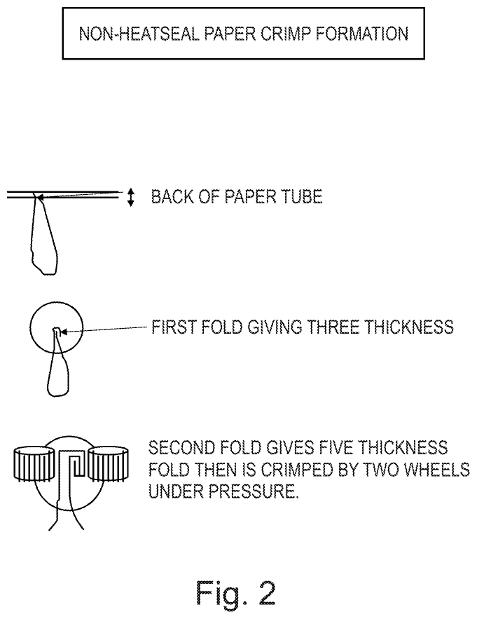

In an embodiment, the filter material is suitable for a tea bag, such as a double chamber tea bag, in particular a non-heatseal double chamber tea bag. Exemplary stages in non-heatseal double chamber bag formation are illustrated in FIG. 1. Moreover, FIG. 2 illustrates the crimp formation of non-heatseal paper.

In an embodiment, the filter material is non-heatsealable. Typically, non-heatsealable filter material does substantially not comprise any heatsealable (or thermoplastic) fibers or, in other words, non-heatsealable filter material is substantially composed of non-heatsealable fibers. Non-heatsealable filter material may be particularly suitable for the production of double chamber tea bags. In an alternative embodiment, the filter material may however also be a heatsealable filter material, i.e. may comprise heatsealable fibers, such as thermoplastic fibers.

The filter material comprises fibers.

In an embodiment, the fibers comprise natural fibers, in particular natural cellulosic fibers, such as wood pulp, wood fibers, hemp fibers, manila fibers, jute fibers, sisal fibers, abaca fibers, kraft pulp or mixtures thereof. The term “natural (cellulosic) fibers”, as used herein, may in particular mean that the (cellulosic) fibers are of natural origin and have not been (synthetically) modified, in contrast to synthetic or semi-synthetic (cellulosic) fibers, such as regenerated cellulose fibers (e.g. viscose or lyocell).

In an embodiment, the fibers comprise cellulosic fibers, in particular selected from the group consisting of wood fibers, hemp fibers, manila fibers, jute fibers, sisal fibers, abaca fibers, kraft pulp, regenerated cellulose fibers or mixtures thereof. Such fibers are particularly advantageous in view of their biodegradability and/or because they are biobased.

The term “biodegradable” which may also be referred to as “compostable”, as used herein, may in particular mean that the material concerned, such as the fibers, the non-fibrous binder or the entire filter material, complies at least with the requirements for industrial compostability, for instance in accordance with at least one of EN 13432, EN 14995, ASTM D5988-18, ASTM D6400-19 and ASTM D6868-19, and preferably also with the requirements for home compostability, for instance in accordance with draft prEN 17427, and may preferably also be marine biodegradable, for instance in accordance with ASTM D6691-17.

The term “biobased” (which may also be referred to as “bio-derived”), as used herein, may in particular mean that the material concerned, such as the fibers, the non-fibrous binder or the entire filter material, can be derived from material of biological or natural origin, in particular from plants or other renewable entities.

In an embodiment, the filter material comprises (based on the total weight of the fibers):
0 to 100 wt.-% of (natural) cellulosic fibers, such as from 10 to 90 wt.-% (natural) cellulosic fibers, in particular from 20 to 80 wt.-% (natural) cellulosic fibers;
0 to 40 wt. % of regenerated (man-made) cellulose fibers, such as from 5 to 30 wt.-% regenerated cellulose fibers, in particular from 10 to 20 wt.-% regenerated cellulose fibers; and
0 to 40 wt.-% of thermoplastic biodegradable fibers, such as from 5 to 30 wt.-% thermoplastic biodegradable fibers, in particular from 10 to 20 wt.-% thermoplastic biodegradable fibers.

The (natural) cellulosic fibers may be selected from wood cellulosic fibers, such as wood pulp (softwood and/or hardwood), and (long) cellulosic fibers (for instance from annual plants) having an average fiber length of from 1 mm to 10 mm, such as from 2 mm to 8 mm, in particular abaca and/or sisal fibers. Wood pulp may in particular denote a (lignocellulosic) fibrous material prepared by chemically or mechanically separating cellulose fibers from wood, such as by a kraft process (sulfate process). Kraft wood pulp may include northern bleached softwood kraft (NBSK) and southern bleached softwood kraft (SBSK) as well as their unbleached variants.

The term “regenerated cellulose fibers”, as used herein, may in particular denote manmade cellulose fibers obtained by a solvent spinning process. In an embodiment, the regenerated cellulose fibers may be selected from the group consisting of viscose (rayon) or lyocell (tencel). Viscose is a type of solvent spun fiber produced according to the viscose process typically involving an intermediate dissolution of cellulose as cellulose xanthate and subsequent spinning to fibers. Lyocell is a type of solvent spun fiber produced according to the aminoxide process typically involving the dissolution of cellulose in N-methylmorpholine N-oxide and subsequent spinning to fibers.

The term “thermoplastic biodegradable fibers”, as used herein, may in particular denote biodegradable fibers that soften and/or partly and/or fully melt when exposed to heat and are capable to bind with each other or to other non-thermoplastic fibers, such as cellulose fibers, upon cooling and resolidifying. For example, the thermoplastic biodegradable fiber may be selected from the group consisting of a polylactic acid (PLA), a polybutylene succinate (PBS), a polybutylene adipate terephthalate (PBAT), a polyhydroxyalkanoate (PHA) and copolymers of PHA, and other fibers made of biodegradable thermoplastic polymers. Combinations of two or more thereof may also be applied.

In an embodiment, the thermoplastic biodegradable fiber comprises a multicomponent fiber, in particular a bicomponent fiber, such as bicomponent fibers of the sheath-core type. Bicomponent fibers are composed of two sorts of polymers having different physical and/or chemical characteristics, in particular different melting characteristics. A bicomponent fiber of the sheath-core type typically has a core of a higher melting point component and a sheath of a lower melting point component.

In an embodiment, substantially all fibers comprised in the filter material may be biodegradable fibers. In other words, it may be advantageous that the filter material does substantially not comprise any other fibers than biodegradable fibers or that the filter material is substantially free of non-biodegradable fibers. With regard to embodiments comprising “substantially no other fibers than biodegradable fibers” or being “substantially free of non-biodegradable fibers”, other fibers than biodegradable fibers, if any, may still be present in relatively minor amounts of up to 10, up to 5, up to 3, up to 2, or up to 1 wt.-% based on the total weight of the non-woven fabric. Non-biodegradable fibers may be present as long as they meet the requirements of the final certification.

The coarseness of the fibers is not particularly limited. Typically, the fibers may have a fiber coarseness of from 0.3 to 3.5 dtex, such as from 0.6 to 2.5 dtex.

The filter material comprises at least one non-fibrous binder.

The term “non-fibrous”, which may synonymously or interchangeably also be referred to as “particulate”, as used herein, may in particular denote that the binder is in the form of particles (characterized for instance by an average particle size), rather than in the form of fibers (characterized for instance by a fiber length or diameter). The term “non-fibrous” in particular serves to differentiate the non-fibrous binder according to the present invention from a binder fiber, as it is sometimes used in a filter material for enhancing the tensile strength.

The term “binder”, as used herein, may in particular denote a compound that is able to bind (e.g. by forming covalent bonds, by ionic interactions or the like) to two or more fibers, thereby interconnecting the fibers, resulting in an increased (tensile) strength of the web or fabric.

The at least one non-fibrous binder is selected from the group consisting of polylactic acid (PLA), polyglycolic acid (PGA) and copolymers thereof (e.g. poly(lactic-co-glycolic acid)). In particular, polylactic acid has proven to be particularly suitable for enhancing the wet tensile strength and/or the wet crimp strength of a filter material. The polylactic acid may be typically selected from the group consisting of poly-D-lactic acid (PDLA), poly-L-lactic acid (PLLA) and poly-D,L-lactic acid (PDLLA).

In an embodiment, the at least one non-fibrous binder is hydrophobic, which may be advantageous in terms of an enhanced wet crimp strength. Without wishing to be bound to any theory, the present inventors assume that a hydrophobic non-fibrous binder may suppress water ingress into the crimped area, thereby enhancing the strength of the crimp even under wet conditions.

In an embodiment, the at least one non-fibrous binder may have an amorphous structure, which may be advantageous in terms of (a faster) biodegradability.

In an embodiment, the at least one non-fibrous binder has an average particle size of less than 100 μm, in particular less than 2.5 μm. The average particle size of the non-fibrous binder may be determined for instance by visual microscopic observation with an appropriate magnification, for instance by using a light optical microscope, an electron microscope (such as a transmission electron microscope (TEM) or a high resolution scanning electron microscope (SEM)) and by randomly selecting an appropriate number of non-fibrous binder particles and calculating the average (such as an arithmetic mean) of the individual sizes.

In an embodiment, the at least one non-fibrous binder is contained in an amount of from 0.1 to 30 wt.-%, such as in an amount of from 0.5 to 25 wt.-%, such as in an amount of from 1 to 20 wt.-%, such as in an amount of from 5 to 18 wt.-%, such as in an amount of from 10 to 15 wt.-%, in particular in an amount of about 12 wt.-%, based on the entire filter material.

In an embodiment, the at least one non-fibrous (particulate) binder is present at substantially an entire surface (or both surfaces) of the filter material. For example, at least 95%, in particular at least 98%, such as 100%, of one or both surface areas of the filter material may be provided with the at least one non-fibrous (particulate) binder. In particular, the at least one non-fibrous (particulate) binder may be present at a crimp portion (crimped area) of a tea bag formed from the filter material.

In an embodiment, the filter material comprises a single layer or a multiple layer web. For instance, the filter material may be manufactured as a single or multiple layer web where the at least one non-fibrous binder may be added either to a single layer product or any layer in a multiple layer product and either the top surface or the bottom surface of the web of the single layer or multiple layer web.

In an embodiment, the filter material may further comprise a wet-strength agent. The term “wet-strength agent”, as used herein, may in particular denote an agent that improves the tensile strength of the filter material in the wet state, for instance by forming covalent bonds. Suitable examples of the wet-strength agent may include a melamine-formaldehyde resin or a polyamine-polyamide-epichlorohydrine resin. The wet-strength agent may be comprised in an amount of from 0.1 to 3 wt.-%, such as in an amount of from 0.2 to 2 wt.-%, such as in an amount of from 0.35 to 1.5 wt.-%, such as in an amount of from 0.5 to 1 wt.-%, based on the total weight of the filter material.

The grammage or basis weight of the filter material according to the present invention is not particularly limited. Typically, the filter material has a grammage of from 8 to 120 g/m², in particular from 9 to 50 g/m², such as from 10 to 30 g/m². The grammage may be determined in accordance with TAPPI T 410 (om-19).

In an embodiment, the filter material is biodegradable. In an embodiment, the filter material complies with the requirements of EN 13432 and preferably with home compostability conditions.

In an embodiment, the filter material has a MD (machine direction) wet tensile strength of at least 20 g/50 mm, for instance up to 30 g/50 mm, such as from 22 to 28 g/50 mm. The wet tensile strength may be determined in accordance with TAPPI T 494 (om-13).

In an embodiment, the filter material has a wet crimp strength of at least 80 g/50 mm, for instance up to 120 g/50 mm, such as from 90 to 110 g/50 mm.

The wet crimp strength may be determined by a test method based on TAPPI T 494, as explained in further detail in the experimental part below.

In an embodiment, the filter material exhibits substantially no wicking (capillary rise, capillary effect), such as a water climb of not more than 5 mm/min, preferably not more than 2 mm/min, most preferably 0 mm/min. The wicking (capillary rise) may be determined in accordance with ISO 8787, NWSP 010.1.R0 (20) or T431 (cm-10).

In an embodiment, the filter material is particularly well suited for hot or cold beverage filtration, as well as filtration under a certain pressure. The filter material can be processed and filled with infusible materials, such as tea or coffee, by means of conventional packaging machines, making it highly suitable for mass-produced articles, such as tea bags.

In an embodiment, the filter material may be obtainable by a process as described herein.

In a second aspect, the present invention relates to the use of a non-fibrous (particulate) binder selected from the group consisting of polylactic acid, polyglycolic acid and copolymers thereof for enhancing wet tensile strength and/or wet crimp strength (preferably without wicking) of a filter material.

In a third aspect, the present invention relates to a process for producing a filter material.

The process comprises the steps of:
providing a web comprising fibers, and
applying at least one non-fibrous (particulate) binder selected from the group consisting of polylactic acid, polyglycolic acid and copolymers thereof to the web.

A (nonwoven) web may be provided (prepared) for instance by a conventional paper-making process using a wet-laid machine, i.e. by a wet-laid process, in particular by means of an inclined wire papermaking machine, as described for instance in U.S. Pat. No. 3,785,922, the disclosure of which is incorporated herein by reference or a fourdrinier paper machine. Alternatively, the (nonwoven) web may be provided (prepared) for instance by a dry-forming air-laid nonwoven manufacturing process, described for instance in U.S. Pat. No. 3,905,864, the disclosure of which is incorporated herein by reference.

Subsequently, the at least one non-fibrous (particulate) binder is applied to the web. In an embodiment, the step of applying the at least one non-fibrous binder comprises applying a liquid (such as a dispersion, emulsion or suspension, for instance in water) comprising the at least one non-fibrous binder, in particular wherein the liquid is applied by means of a size press and/or by at least one technique selected from the group consisting of impregnating, coating, printing and spraying. In a preferred embodiment, the at least one non-fibrous binder may be applied by means of a size-press. By taking this measure, it may be possible to apply the at least one non-fibrous binder in a very efficient manner at substantially an entire surface (or both surfaces) or within the entire structure of the filter material.

In an embodiment, the process further comprises, a step of drying the filter material, in particular if the web has been prepared by means of a wet-laid process.

In an embodiment, the process further comprises, after the step of applying the at least one non-fibrous binder (and optionally drying the filter material), a step of heating the filter material, in particular to a temperature of at least 125° C., preferably at least 150° C., in particular at a temperature sufficient to melt or cure the binder and bind it to the fibers.

In an embodiment, the process may be suitable for producing a filter material as described herein.

In a fourth aspect, the present invention relates to food packaging (such as pouches), in particular a tea bag, comprising or made from the filter material.

In an embodiment, the food packaging is a tea bag, wherein the at least one non-fibrous binder is present throughout the entire filter material (over the entire area or surface of the filter material), in particular at a crimp portion (crimped area) of the tea bag.

The present invention is further described by the following examples, which are solely for the purpose of illustrating specific embodiments, and are not construed as limiting the scope of the invention in any way.

### Examples

Filter materials having a composition as indicated below have been prepared and tested for specific properties, in particular dry and wet tensile strength, dry and wet crimp strength as well as water climb (vertical capillary rise, wicking).

As a base substrate for all evaluated filter materials, a conventional non-heatsealable abaca wood paper containing a wet-strength agent but no binders and having a basis weight of 12.7 g/m² was used (designated in the following as “612 base standard”). To this 612 base standard, various binders as indicated below were applied by means of a size press and curing was carried out for 10 seconds at 200° C. in a laboratory oven. As a reference example, a sample of the 612 base standard was size pressed with water (i.e. containing no binder) and treated otherwise in the same manner as the samples where a binder has been applied.

Synthetic binders, such as methyl acrylate binders, are available for instance from BTC Europe GmbH (BASF SE), Clariant AG or Rohm and Haas (Dow Chemical). Polybutylene succinate (PBS) binders are available for instance from Mitsubishi Chemical Corporation or Ueno Fine Chemicals Industry, Ltd. Polylactic acid (PLA) binders are available for instance from SK Chemicals or Unitika Ltd.

### Comparative Examples

612 base standard (not size pressed)
612 base (size pressed with water)
612 base+1.5% CMC (carboxymethyl cellulose; biobased binder; meets EN 13432)
612 base+6% synthetic methyl acrylate binder; not biodegradable
612 base+12% synthetic methyl acrylate binder; not biodegradable
612 base+6% polybutylene succinate; biodegradable binder
612 base+12% polybutylene succinate; biodegradable binder

### Examples According to the Invention

612 base+6% PLA binder type A
612 base+12% PLA binder type A
612 base+6% PLA binder type B
612 base+12% PLA binder type B
612 base+6% PLA binder type C
612 base+12% PLA binder type C

### Test Methods

### Dry and Wet Tensile Strength:

The dry and wet tensile strengths of the filter materials were determined in accordance with TAPPI T 494 (om-13) Tensile Properties of paper and paperboard using constant rate of elongation apparatus. “MD dry tensile” means the dry tensile strength in machine direction and “wet MD tensile” means the wet tensile strength in machine direction.

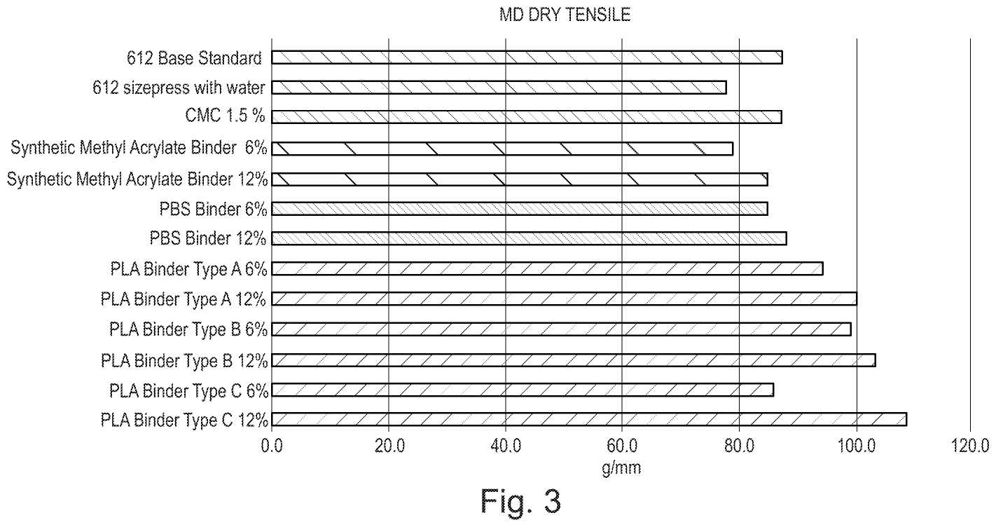

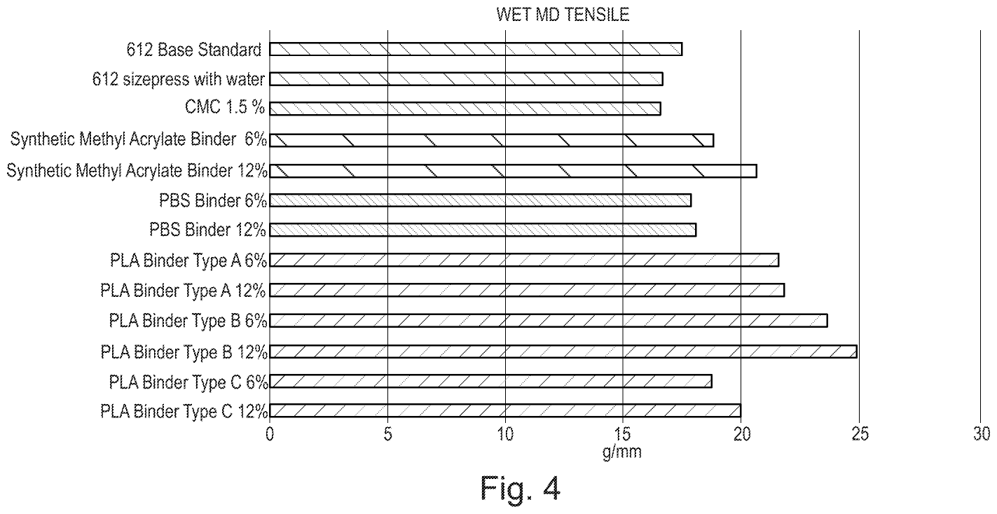

The results of the measurements of the MD dry tensile strength of the tested filter materials are shown in FIG. 3 and the results of the measurements of the MD wet tensile strength of the tested filter materials are shown in FIG. 4.

### Dry and Wet Crimp Strength:

The dry and wet crimp strengths of the filter materials were determined by a test method based on the tensile strength test method TAPPI T 494, constant rate of elongation, as elucidated in further detail below:

### Dry Crimp Strength:

A sheet was folded once in half in the MD direction. On the edge opposite to the fold, a narrow 1 mm strip containing the 2 edges is folded back. This initial fold is then folded twice more, ensuring the folds are tight and do not increase the width of the folded narrow strip to beyond 2 mm.
The 3 times folded edge of the paper is then run through a crimping wheel apparatus composed of 2 knurled gear wheels. The base wheel is 3 mm wide, composing 104 teeth and a diameter of 28 mm. The top wheel is 1 mm wide composing 82 teeth and has a diameter of 25 mm. 8 samples are cut from the crimped strip, 50 mm wide.
The original folded edge is cut on each sample to give 2 tails which are clamped into the jaws of a tensile testing machine.
The 50 mm wide formed crimps are pulled apart at 50 mm/min and the resultant peak load expressed in g/50 mm.

### Wet Crimp Strength:

The crimped samples are formed as above and mounted in the jaws of the tensile tester. Water at 20° C. is sprayed onto the crimp immediately prior to pulling the crimp apart at 50 mm/min. The resultant peak load is expressed in g/50 mm.

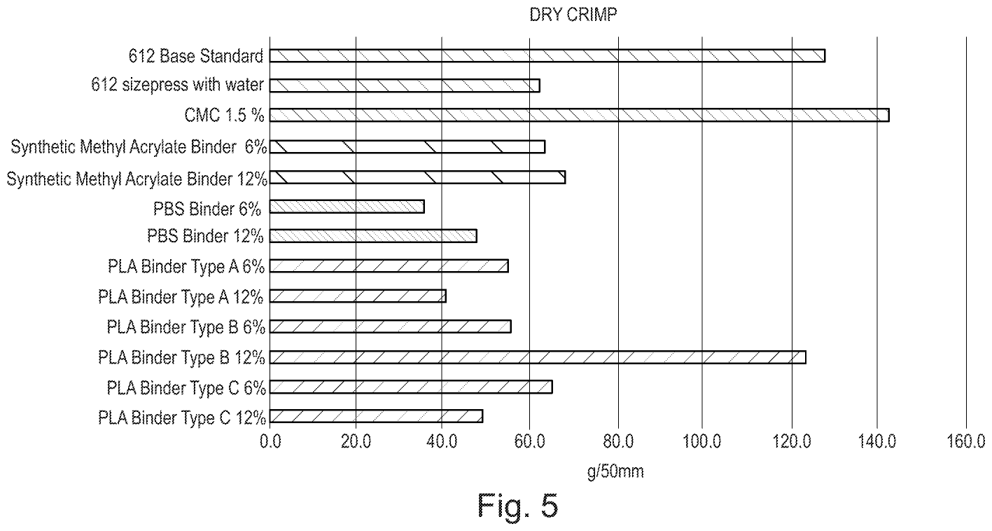

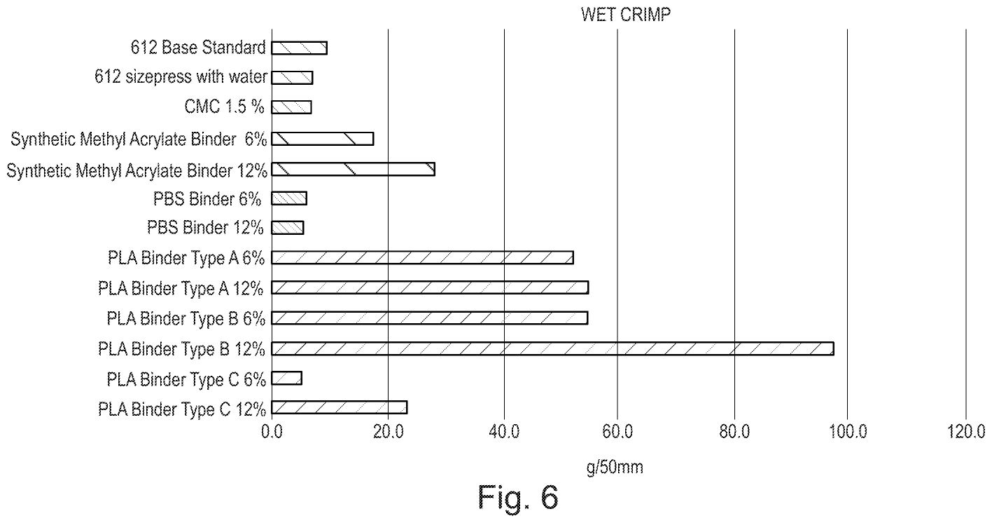

The results of the measurements of the dry crimp strength of the tested filter materials are shown in FIG. 5 and the results of the measurements of the wet crimp strength of the tested filter materials are shown in FIG. 6.

### Water Climb (Vertical Capillary Rise, Wicking):

The water climb of the filter materials were determined by a test method similar to ISO 8787 paper and board, capillary rise—Klemm method, as elucidated in further detail below:

### 1 Introduction

This method is used to determine the degree of hydrophobicity of paper via the rate at which water is absorbed by capillary action.

### 2.0 Apparatus

Ruler
Water
250 ml glass beaker
25 mm width template or guillotine
Stopwatch
Bulldog clips
Stand and clamp.

### 3.0 Experimental Details

3.1 Cut a sample strip 25 mm wide and a minimum of 180 mm long.
3.2 Using a pencil, mark the paper strip with two straight lines across its width at 50 mm (Position A) and 60 mm (Position B) from one end.

### 4 Method

4.1 Attach a bulldog clip to each end of the paper strip and hang vertically from the clamp/stand. The bottom end of the strip is immersed in a beaker of water, and the clamp height adjusted such that the lowest pencil line (Position A) is parallel with the water surface.
4.2 If the paper is not completely hydrophobic the water will begin to climb up the paper strip. When the last part of the wet-line crosses the second pencil line (Position B) start the stopwatch.
4.3 When 10 minutes have elapsed mark the position on the strip of the lowest point of the wet-line (Position C)
4.4 Remove the strip from the clamp and bulldog clips and lay on a dark surface. Measure the distance from Position B to position C in mm.

### 5.0 Results

The wicking rate is the distance measured in 4.4 and is quoted in units of mm/10 mins.

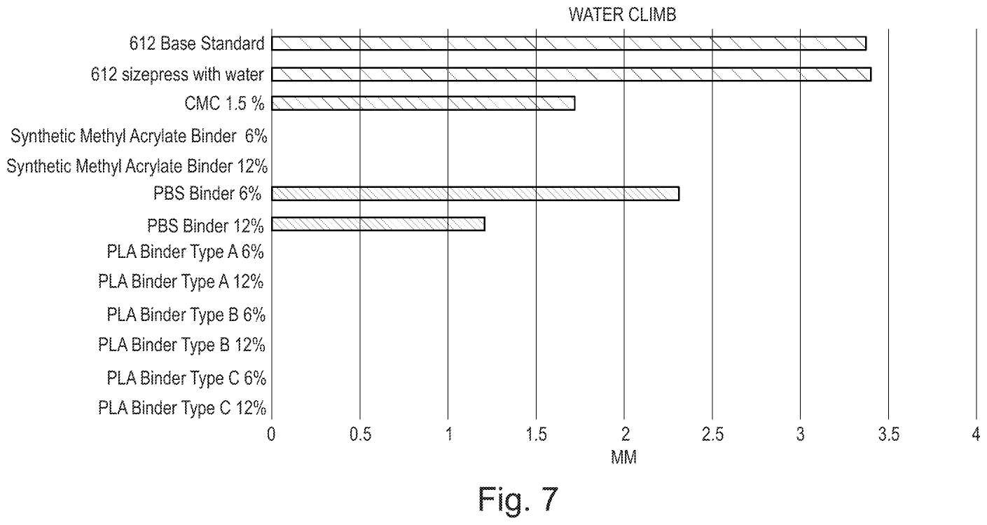

The results of the measurements of the wet climb of the tested filter materials are shown in FIG. 7.

### CONCLUSIONS

As it is evident from the results shown in FIGS. 3 and 4, the filter materials according to the present invention using a biobased and biodegradable PLA binder are superior in tensile strength both in the dry state and in particular also in the wet state over biobased binders, such as CMC, and other biodegradable binders, such as PBS, and even over conventional synthetic binders, such as methyl acrylate binders. Thus, the filter materials according to the present invention may fully comply with the requirements of a current hot and cold beverage bag using existing synthetic binder materials.

As it is evident from the results shown in FIGS. 5 and 6, while exhibiting a comparable dry crimp strength as some of the conventional binders or as filter materials without a binder, the filter materials according to the present invention using a biobased and biodegradable PLA binder exhibit a largely enhanced wet crimp strength over biobased binders, such as CMC, and other biodegradable binders, such as PBS, and even over conventional synthetic binders. Thus, the filter materials according to the present invention may efficiently prevent or significantly reduce ruptures at the crimp portion (crimped area) of a tea bag in the wet state, thereby avoiding leakages of solid tea particles upon brewing.

Moreover, as evident from the results shown in FIG. 7, the filter materials according to the present invention using a biobased and biodegradable PLA binder exhibit substantially no wicking effect, in contrast to several of the Comparative Examples, which is indicative that the filter materials according to the present invention have a high degree of hydrophobicity involving an enhanced wet crimp strength due to suppression of water ingress into the crimped area.

While the present invention has been described in detail by way of specific embodiments and examples, the invention is not limited thereto and various alterations and modifications are possible, without departing from the scope of the invention.

1. A filter material comprising:
(a) fibers; and
(b) at least one non-fibrous binder selected from the group consisting of polylactic acid, polyglycolic acid and copolymers thereof.

2. The filter material according to claim 1, wherein the fibers comprise cellulosic fibers selected from the group consisting of wood fibers, hemp fibers, manila fibers, jute fibers, sisal fibers, abaca fibers, kraft pulp, regenerated cellulose fibers or mixtures thereof.

3. The filter material according to claim 1, wherein the filter material comprises:
0 to 100 wt.-% of cellulosic fibers;
0 to 40 wt. % of regenerated cellulose fibers;
0 to 40 wt.-% of thermoplastic biodegradable fibers.

4. The filter material according to claim 1, wherein the at least one non-fibrous binder comprises polylactic acid.

5. The filter material according to claim 1, wherein the at least one non-fibrous binder has an average particle size of less than 100 μm.

6. The filter material according to claim 1, wherein the at least one non-fibrous binder is contained in an amount of from 0.1 to 30 wt.-% based on the entire filter material.

7. The filter material according to claim 1, wherein the filter material further comprises a wet-strength agent.

8. The filter material according to claim 1, wherein the filter material fulfils at least one of the following properties:
the filter material is biodegradable;
the filter material has a wet tensile strength of at least 20 g/50 mm;
the filter material has a wet crimp strength of at least 80 g/50 mm;
the filter material exhibits substantially no wicking.

9. A method of using a non-fibrous binder selected from the group consisting of polylactic acid, polyglycolic acid and copolymers thereof for enhancing wet tensile strength and/or wet crimp strength of a filter material.

10. A process for producing a filter material, comprising the steps of
providing a web comprising fibers, and
applying at least one non-fibrous binder selected from the group consisting of polylactic acid, polyglycolic acid and copolymers thereof to the web.

11. The process according to claim 10, wherein the step of providing the web comprises forming the web by a wet-laid process.

12. The process according to claim 10, wherein the step of applying the at least one non-fibrous binder comprises applying a liquid comprising the at least one non-fibrous binder.

13. The process according to claim 10, further comprising, after the step of applying the at least one non-fibrous binder, a step of heating the filter material to a temperature of at least 125° C.

14. A food packaging comprising a filter material, the filter material comprising:
(a) fibers; and
(b) at least one non-fibrous binder selected from the group consisting of polylactic acid, polyglycolic acid and copolymers thereof.

15. The food packaging according to claim 14, wherein the food packaging is a tea bag.

16. The food packaging according to claim 15, wherein the at least one non-fibrous binder is present at the entire filter material.

17. The food packaging according to claim 15, wherein the at least one non-fibrous binder is present at a crimp portion of the tea bag.

18. The filter material according to claim 1, wherein the fibers comprise natural fibers.

19. The filter material according to claim 1, wherein the fibers are selected from the group consisting of wood pulp, wood fibers, hemp fibers, manila fibers, jute fibers, sisal fibers, abaca fibers, kraft pulp, regenerated cellulose fibers or mixtures thereof.

20. The filter material according to claim 2, wherein the cellulosic fibers have an average fiber length of from 1 mm to 10 mm.
